(19) United States
(12) Patent Application Publication
(10) Pub. No.: US 2024/0104358 A1
(43) Pub. Date: Mar. 28, 2024

(54) METHOD AND SYSTEM FOR GENERATION OF INTERPRETABLE TIME SERIES WITH IMPLICIT NEURAL REPRESENTATIONS

(71) Applicant: JPMorgan Chase Bank, N.A., New York, NY (US)

(72) Inventors: Elizabeth FONS, London (GB); Svitlana VYETRENKO, Colts Neck, NJ (US); Yousef EL-LAHAM, Dallas, TX (US); Alejandro SZTRAJMAN, London (GB); Alexandros IOSIFIDIS, Aarhus (DK)

(73) Assignee: JPMorgan Chase Bank, N.A., New York, NY (US)

(21) Appl. No.: 18/215,499

(22) Filed: Jun. 28, 2023

(30) Foreign Application Priority Data
Sep. 27, 2022 (GR) 20220100789

(51) Int. Cl. G06N 3/048

(52) U.S. Cl. CPC G06N 3/048

(57) ABSTRACT

A method and a system for using implicit neural representations for generation of interpretable time series are provided. The method includes: receiving time series information, such as pairings of time coordinate values with time series signal values, that relates to an event sequence; generating, based on the time series information, an implicit neural representation of the event sequence that includes a plurality of embedded values and a corresponding plurality of weights; and using the implicit neural representation to predict at least one item of information that relates to the event sequence and is not included in the received time series information, such as an interpolation or an extrapolation of the time series.

### CROSS-REFERENCE TO RELATED APPLICATIONS

This application claims priority benefit from Greek Application No. 202201000789, filed Sep. 27, 2022, which is hereby incorporated by reference in its entirety.

### BACKGROUND

### 1. Field of the Disclosure

This technology generally relates to methods and systems for generating time series data, and more particularly to methods and systems for using implicit neural representations for generation of interpretable time series.

### 2. Background Information

Modeling time series data has been a key topic of research for many years, constituting a crucial component of applications in a wide variety of areas such as climate modeling, medicine, biology, retail and finance. Traditional methods for time series modeling have relied on parametric models informed by expert knowledge. However, the development of modern machine learning methods has provided purely data-driven techniques to learn temporal relationships. In particular, neural network-based methods have gained popularity in recent times, with applications on a wide range of tasks, such as time series classification, clustering, segmentation, anomaly detection, imputation, forecasting and synthesis. In particular, the generation of time series data for augmentation has remained as an open problem, and is currently gaining interest due to the large number of potential applications such as in medical and financial datasets, where data cannot be shared, either due to privacy reasons or proprietary or where datasets tend to be small. In the case of insufficient data, generating synthetic samples can improve performance on downstream tasks such as regression, by improving model regularization and generalization.

In recent years, implicit neural representations (INRs) have gained popularity as an accurate and flexible method to parameterize signals, such as from image, video, audio and three-dimensional (3-D) scene data. Conventional methods for data encoding often rely on discrete representations, such as data grids, which are limited by their spatial resolution and present inherent discretization artifacts. By contrast, implicit neural representations encode data in terms of continuous functional relationships between signals, and thus are uncoupled to spatial resolution. In practical terms, INRs provide a new data representation framework that is resolution-independent, with many potential applications on time series data, where irregularly sampled and missing data are common occurrences.

Implicit Neural Representations: INRs, also referred to herein as coordinate-based neural networks, have recently gained popularity in computer vision applications. The usual implementation of INRs consists of a fully connected neural network, i.e., a multi-layer perceptron (MLP), that maps coordinates (such as, for example, xyz-coordinates) to the corresponding values of the data, essentially encoding their functional relationship in the network. One of the main advantages of this approach for data representation is that the information is encoded in a continuous/grid-free representation that provides a built-in non-linear interpolation of the data. This avoids the usual artifacts that arise from discretization, and has been shown to combine flexible and accurate data representation, with high memory efficiency. While INRs have been shown to work on data from diverse sources, such as video, images and audio, their recent popularity has been motivated by multiple applications in the representation of 3D scene data, such as 3D geometry and object appearance.

In early architectures, INRs showed a lack of accuracy in the encoding of high-frequency details of signals. Positional encodings were proposed to address this issue, and it was subsequently shown that by using Fourier-based features in the input layer, the network is able to learn the full spectrum of frequencies from data. Concurrently, the encoding of high-frequency data was also addressed by proposing the use of sinusoidal activation functions, i.e., SInusoidal REpresentation Networks (SIRENs), and an equivalence between Fourier features and single-layer SIRENs was shown.

Hypernetworks: A hypernetwork is a neural network architecture designed to predict the weight values of a secondary neural network, which may be referred to as a HypoNetwork. While convolutional encoders have been likened to the function of the human visual system, this analogy cannot be extended to convolutional decoders, and some researchers have argued that hypernetworks much more closely match the behavior of the prefrontal cortex. Hypernetworks have been praised for their expressivity, compression due to weight sharing, and for their fast inference times. They have been leveraged for multiple applications, including few-shot learning, continual learning and architecture search. Recently, there have been efforts to leverage hypernetworks for the training of INRs, enabling the learning of latent encodings of data, while also maintaining the flexible and accurate reconstruction of signals provided by INRs. This approach has been implemented with different hypernetwork architectures, to learn priors over image data, 3D scene geometry and material appearance. Hypernetworks have also been leveraged to speed-up the training of INRs by providing learned initializations of the network weights. A combination of a set encoder with a hypernetwork decoder has been proposed to learn a prior over INRs representing image data, and apply it for image in-painting.

Time Series Generation: Realistic time series generation has been previously studied by using the generative adversarial networks (GANs). In TimeGAN architecture, realistic generation of temporal patterns has been achieved by jointly optimizing with both supervised and adversarial objectives to learn an embedding space. QuantGAN consists of generator and discriminator functions represented by temporal convolutional networks, allowing it to synthesize long-range dependencies such as the presence of volatility clusters that are characteristic of financial time series. TimeVAE was recently proposed as a variational autoencoder alternative to GAN-based time series generation. GANs and VAEs are typically used for creating statistical replicas of the training data, and not the distributionally new scenarios needed for data augmentation. More recently, Fourier Flows have been proposed as a normalizing flow model for time series data that leverages the frequency domain representation, currently considered together with TimeGAN as state-of-the-art for time series augmentation.

Data augmentation is well established in computer vision tasks due to the simplicity of label preserving geometric image transformation techniques, but it is still not widely used for time series. For example, simple augmentation techniques applied to financial price time series, such as adding noise or time warping, have been shown to improve the quality of next day price prediction model.

Accordingly, there is a need for a mechanism for using implicit neural representations for generation of interpretable time series.

### SUMMARY

The present disclosure, through one or more of its various aspects, embodiments, and/or specific features or sub-components, provides, inter alia, various systems, servers, devices, methods, media, programs, and platforms for methods and systems for using implicit neural representations for generation of interpretable time series.

According to an aspect of the present disclosure, a method for generating an interpretable time series is provided. The method is implemented by at least one processor. The method includes: receiving, by the at least one processor, first information that relates to an event sequence; generating, by the at least one processor based on the first information, an implicit neural representation of the event sequence that includes a plurality of embedded values and a corresponding plurality of weights; and using the implicit neural representation to predict at least one item of second information that relates to the event sequence and is not included in the first information.

Each of the first information and the second information may include at least one respective pairing of a time coordinate value with a time series signal value.

The second information may include at least one interpolated pairing for which a corresponding time coordinate value indicates a time that occurs before a latest time that is indicated by time coordinate values included in the first information.

The second information may include at least one extrapolated pairing for which a corresponding time coordinate value indicates a time that occurs after a latest time that is indicated by time coordinate values included in the first information.

The generating of the implicit neural representation may include applying a sinusoidal representation network that uses at least one sinusoidal function as a periodic activation function and includes fully connected layers having a predetermined dimensionality.

The predetermined dimensionality may be equal to 1×60×60×60×1.

The implicit neural representation may include a trend component and a seasonality component.

The second information may include a trend output and a seasonality output that is separable from the trend output.

The event sequence may include at least one from among a first event sequence that relates to climate modeling, a second event sequence that relates to a medical situation, a third event sequence that relates to a biological situation, a fourth event sequence that relates to a retail situation, and a fifth event sequence that relates to a financial market situation.

According to another exemplary embodiment, a computing apparatus for generating an interpretable time series is provided. The computing apparatus includes a processor; a memory; and a communication interface coupled to each of the processor and the memory. The processor is configured to: receive, via the communication interface, first information that relates to an event sequence; generate, based on the first information, an implicit neural representation of the event sequence that includes a plurality of embedded values and a corresponding plurality of weights; and use the implicit neural representation to predict at least one item of second information that relates to the event sequence and is not included in the first information.

Each of the first information and the second information may include at least one respective pairing of a time coordinate value with a time series signal value.

The second information may include at least one interpolated pairing for which a corresponding time coordinate value indicates a time that occurs before a latest time that is indicated by time coordinate values included in the first information.

The second information may include at least one extrapolated pairing for which a corresponding time coordinate value indicates a time that occurs after a latest time that is indicated by time coordinate values included in the first information.

The processor may be further configured to generate the implicit neural representation by applying a sinusoidal representation network that uses at least one sinusoidal function as a periodic activation function and includes fully connected layers having a predetermined dimensionality.

The predetermined dimensionality may be equal to 1×60×60×60×1.

The implicit neural representation may include a trend component and a seasonality component.

The second information may include a trend output and a seasonality output that is separable from the trend output.

The event sequence may include at least one from among a first event sequence that relates to climate modeling, a second event sequence that relates to a medical situation, a third event sequence that relates to a biological situation, a fourth event sequence that relates to a retail situation, and a fifth event sequence that relates to a financial market situation.

According to yet another exemplary embodiment, a non-transitory computer readable storage medium storing instructions for generating an interpretable time series is provided. The storage medium includes executable code which, when executed by a processor, causes the processor to: receive first information that relates to an event sequence; generate, based on the first information, an implicit neural representation of the event sequence that includes a plurality of embedded values and a corresponding plurality of weights; and use the implicit neural representation to predict at least one item of second information that relates to the event sequence and is not included in the first information.

Each of the first information and the second information may include at least one respective pairing of a time coordinate value with a time series signal value.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for using implicit neural representations for generation of interpretable time series.

FIG. 4 is a flowchart of an exemplary process for implementing a method for using implicit neural representations for generation of interpretable time series.

FIG. 5 is a diagram that illustrates an implicit neural representation for univariate time series, according to an exemplary embodiment.

FIG. 6 is a diagram that illustrates an implicit neural representation with a trend component and a seasonality component for univariate time series, according to an exemplary embodiment.

FIG. 7 is a diagram that illustrates a network architecture for implementing a method for using implicit neural representations for generation of interpretable time series, according to an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

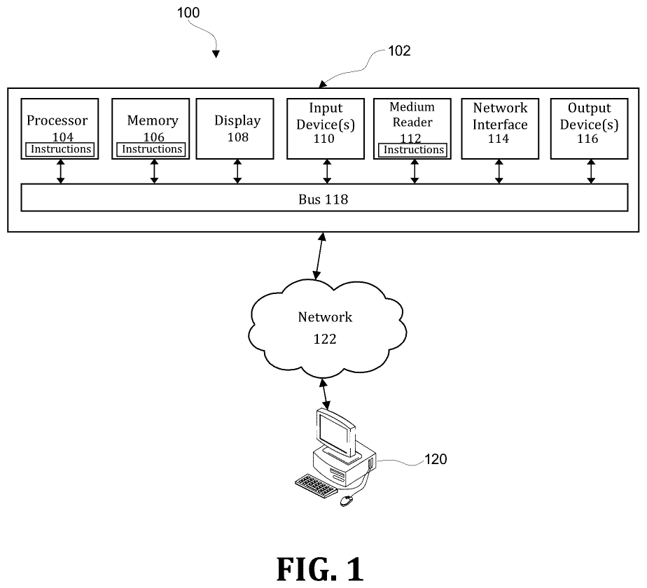

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is illustrated in FIG. 1 as a wireless network, those skilled in the art appreciate that the network 122 may also be a wired network.

The additional computer device 120 is illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for using implicit neural representations for generation of interpretable time series.

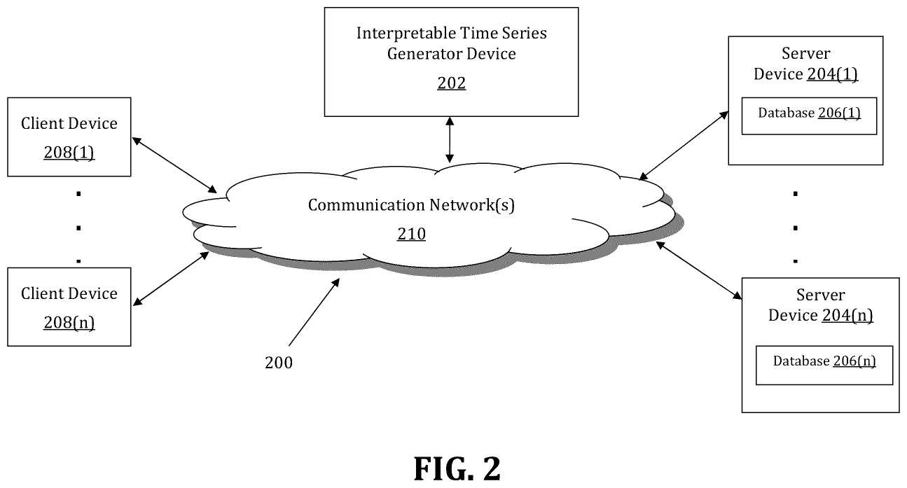

Referring to FIG. 2, a schematic of an exemplary network environment 200 for implementing a method for using implicit neural representations for generation of interpretable time series is illustrated. In an exemplary embodiment, the method is executable on any networked computer platform, such as, for example, a personal computer (PC).

The method for using implicit neural representations for generation of interpretable time series may be implemented by an Interpretable Time Series Generator (ITSG) device 202. The ITSG device 202 may be the same or similar to the computer system 102 as described with respect to FIG. 1. The ITSG device 202 may store one or more applications that can include executable instructions that, when executed by the ITSG device 202, cause the ITSG device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the ITSG device 202 itself, may be located in virtual server(s) running in a cloud-based computing environment rather than being tied to one or more specific physical network computing devices. Also, the application(s) may be running in one or more virtual machines (VMs) executing on the ITSG device 202. Additionally, in one or more embodiments of this technology, virtual machine(s) running on the ITSG device 202 may be managed or supervised by a hypervisor.

In the network environment 200 of FIG. 2, the ITSG device 202 is coupled to a plurality of server devices 204(1)-204(n) that hosts a plurality of databases 206(1)-206(n), and also to a plurality of client devices 208(1)-208(n) via communication network(s) 210. A communication interface of the ITSG device 202, such as the network interface 114 of the computer system 102 of FIG. 1, operatively couples and communicates between the ITSG device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the ITSG device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and ITSG devices that efficiently implement a method for using implicit neural representations for generation of interpretable time series.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The ITSG device 202 may be a standalone device or integrated with one or more other devices or apparatuses, such as one or more of the server devices 204(1)-204(n), for example. In one particular example, the ITSG device 202 may include or be hosted by one of the server devices 204(1)-204(n), and other arrangements are also possible. Moreover, one or more of the devices of the ITSG device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the ITSG device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store time series data and data that relates to neural network parameters.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the ITSG device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the ITSG device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the ITSG device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the ITSG device 202, the server devices 204(1)-204(n), or the client devices 208(1)-208(n), for example, may be configured to operate as virtual instances on the same physical machine. In other words, one or more of the ITSG device 202, the server devices 204(1)-204(n), or the client devices 208(1)-208(n) may operate on the same physical device rather than as separate devices communicating through communication network(s) 210. Additionally, there may be more or fewer ITSG devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the internet, intranets, and combinations thereof.

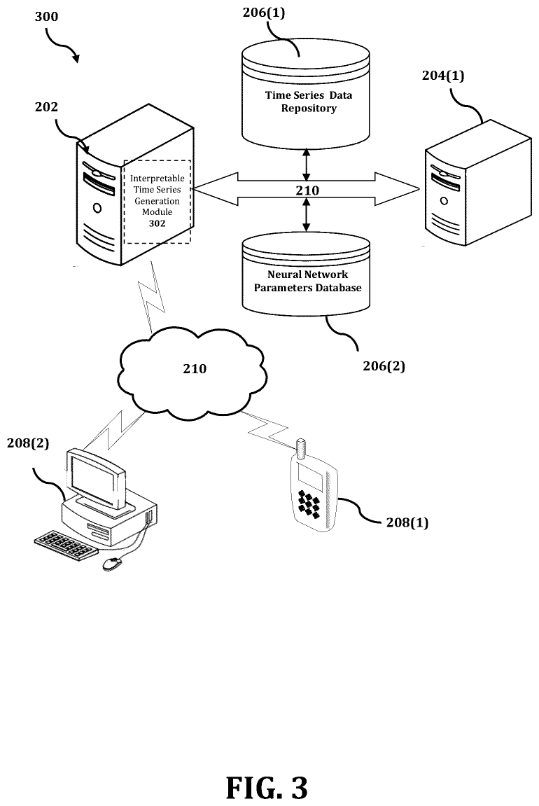

The ITSG device 202 is described and illustrated in FIG. 3 as including an interpretable time series generation module 302, although it may include other rules, policies, modules, databases, or applications, for example. As will be described below, the interpretable time series generation module 302 is configured to implement a method for using implicit neural representations for generation of interpretable time series.

An exemplary process 300 for implementing a mechanism for using implicit neural representations for generation of interpretable time series by utilizing the network environment of FIG. 2 is illustrated as being executed in FIG. 3. Specifically, a first client device 208(1) and a second client device 208(2) are illustrated as being in communication with ITSG device 202. In this regard, the first client device 208(1) and the second client device 208(2) may be “clients” of the ITSG device 202 and are described herein as such. Nevertheless, it is to be known and understood that the first client device 208(1) and/or the second client device 208(2) need not necessarily be “clients” of the ITSG device 202, or any entity described in association therewith herein. Any additional or alternative relationship may exist between either or both of the first client device 208(1) and the second client device 208(2) and the ITSG device 202, or no relationship may exist.

Further, ITSG device 202 is illustrated as being able to access a time series data repository 206(1) and a neural network parameters database 206(2). The interpretable time series generation module 302 may be configured to access these databases for implementing a method for using implicit neural representations for generation of interpretable time series.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the ITSG device 202 via broadband or cellular communication. Of course, these embodiments are merely exemplary and are not limiting or exhaustive.

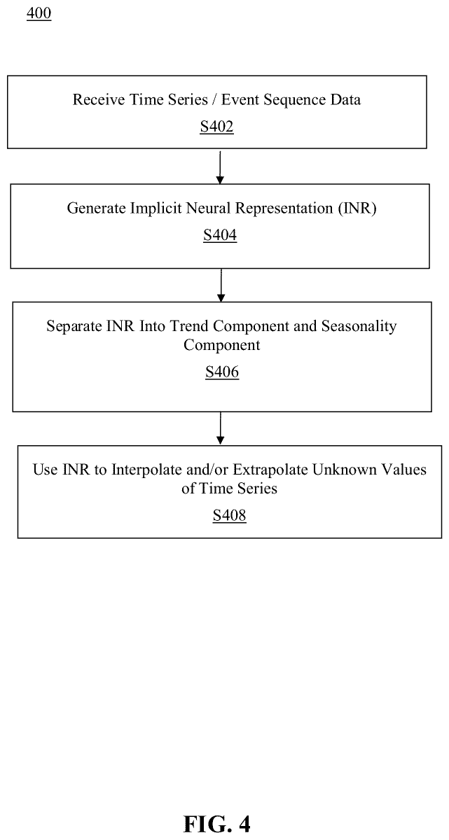

Upon being started, the interpretable time series generation module 302 executes a process for using implicit neural representations for generation of interpretable time series. An exemplary process for using implicit neural representations for generation of interpretable time series is generally indicated at flowchart 400 in FIG. 4.

In process 400 of FIG. 4, at step S402, the interpretable time series generation module 302 receives first information that relates to an event sequence. In an exemplary embodiment, the first information includes time series data, i.e., pairings of time coordinate values with time series signal values. The event sequence may include any one or more of a first event sequence that relates to climate modeling, a second event sequence that relates to a medical situation, a third event sequence that relates to a biological situation, a fourth event sequence that relates to a retail situation, and a fifth event sequence that relates to a financial market situation.

At step S404, the interpretable time series generation module 302 uses the first information to generate an implicit neural representation (INR) of the event sequence. In an exemplary embodiment, the (INR) is generated by applying a sinusoidal representation network that uses at least one sinusoidal function as a periodic activation function and includes fully connected layers having a predetermined functionality, such as, for example, a dimensionality of 1×60×60×60×1.

At step S406, the interpretable time series generation module 302 separates the INR into a trend component and a seasonality component. In an exemplary embodiment, a trend is the presence of a long-term increase or decrease in the event sequence. In an exemplary embodiment, seasonality refers to a variation that occurs at specific regular intervals that are typically of less than a year. Seasonality may occur on different time spans such as daily, weekly, monthly, or yearly.

At step S408, the interpretable time series generation module 302 uses the INR to predict at least one unknown item of information that relates to the event sequence. In an exemplary embodiment, the items of information to be predicted include pairings of time coordinate values with time series signal values that are not included in the first information received in step S402. For example, the items of information to be predicted may include one or more interpolations, i.e., items for which the respective time coordinate value indicates a time that occurs before a latest time that is indicated by the time coordinate values included in the first information. Alternatively, the items of information to be predicted may include one or more extrapolations, i.e., items for which the respective time coordinate value indicates a time that occurs after the latest time that is indicated by the time coordinate values included in the first information. In an exemplary embodiment, each respective item of information to be predicted may include a trend output and a seasonality output that is separable from the corresponding trend output.

In an exemplary embodiment, step S408 may be realized as follows: The time series is encoded into an embedding using the INR. The embedding includes the trend component and the seasonality component. The interpolation is manifested as a new embedding, which is then used as input for two hypernetworks. The outputs of the hypernetworks are additional INRs that correspond to the trend component and the seasonality component, and these additional INRs are then added to form the full time series, i.e., they are the predicted items of information described above.

In an exemplary embodiment, the process 400 may be used to generate synthetic data sets that relate to the event sequence. In this aspect, the items of information to be predicted in step S408 may include synthetic data that relates to the event sequence and/or the time series represented by the pairings of time coordinates and time series signal values encoded in the INR.

In an exemplary embodiment, an analysis of the representation of time series using INRs includes a comparison between different activation functions in terms of reconstruction accuracy and training convergence speed. A description of how these networks can be leveraged for the imputation of time series is provided, with applications on both univariate and multivariate data. In addition, a hypernetwork architecture that leverages INRs to learn a compressed latent representation of an entire time series dataset is described. An introduction is made of a loss that is based on Fast Fourier Transforms (FFTs) to guide training so that all frequencies are preserved in the time series. It is shown that this type of network can be used to encode time series as INRs, and their embeddings can be interpolated to generate new time series from existing ones.

Formulation: The following provides a description of network architectures that are usable in an exemplary embodiment to encode time series data, as well as a hypernetwork architecture that is leveraged for prior learning and new data generation.

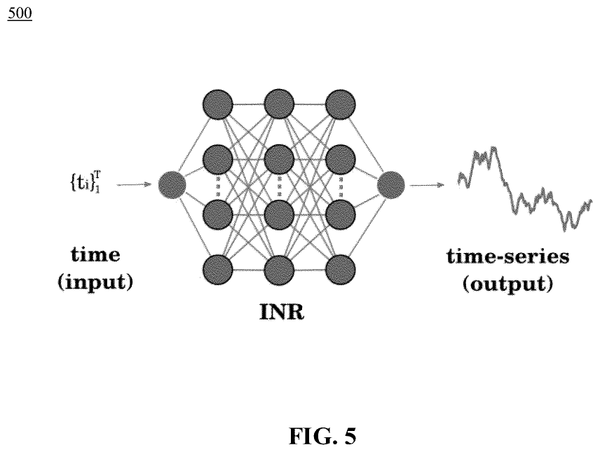

FIG. 5 is a diagram 500 that illustrates an implicit neural representation (INR) for univariate time series, according to an exemplary embodiment. The network is a SInusoidal REpresentation Network (SIREN) composed of fully-connected layers of dimensions 1×60×60×60×1, with sine activations:

ϕⱼ(xᵢ)=sin(ω₀Wⱼxᵢ+bⱼ) (Expression 1)

where ϕ(⋅) corresponds to the j^{th} layer of the network. A general factor Wo multiplying the network weights determines the order of magnitude of the frequencies that are used to encode the signal. Input and output of the INR are uni-dimensional, and correspond to the time coordinate t and the time series evaluation ƒ(t). Training of the network is done in a supervised manner, with mean squared error (MSE) loss, and takes less than 10 seconds in a GeForce GTX 1080 Ti GPU. After training, the network encodes a continuous representation of the functional relationship ƒ(t) for a single time series. The architecture 500 can be modified to encode multivariate time series, by simply increasing the number of neurons of the output layer to match the number of channels of the signal. Due to weight-sharing, this adds a potential for data compression of the time series.

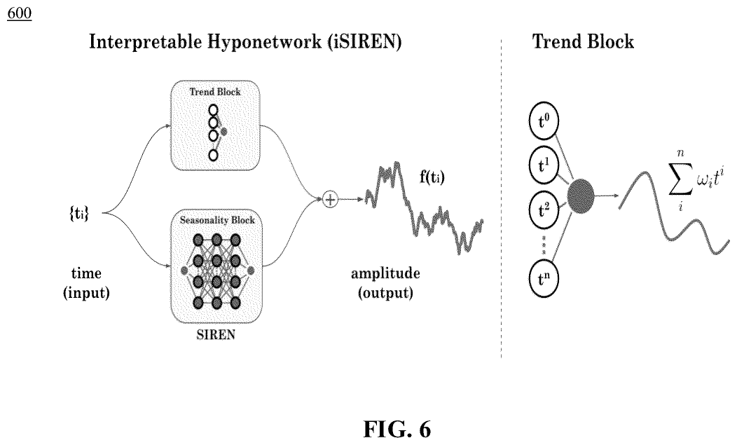

FIG. 6 is a diagram 600 that illustrates an implicit neural representation with a trend component and a seasonality component for univariate time series, according to an exemplary embodiment.

Interpretability: Referring to FIG. 6, an interpretable architecture to encode time series that reuses the INR with sine activation functions is described below. As illustrated in diagram 600, a classic time series additive decomposition that separates the time series into trend and seasonality is provided.

ƒ(t)=Sₜ+Tₜ (Expression 2)

Trend block: Since the trend tends to be a monotonic function, it may be modeled with a polynomial.

$${T}_{t} = {\sum }_{i = 0}^{p} {W}_{i}^{( T )} {t}^{i} \qquad ( Expression 3 )$$

While the training of the model allows to use any degree of polynomial, in an exemplary embodiment, a small degree of p=3 may be chosen.

Seasonality block: Given that INRs with sine activation functions are particularly good for modeling of periodic signals, the INR of FIG. 5 is used as the seasonality block.

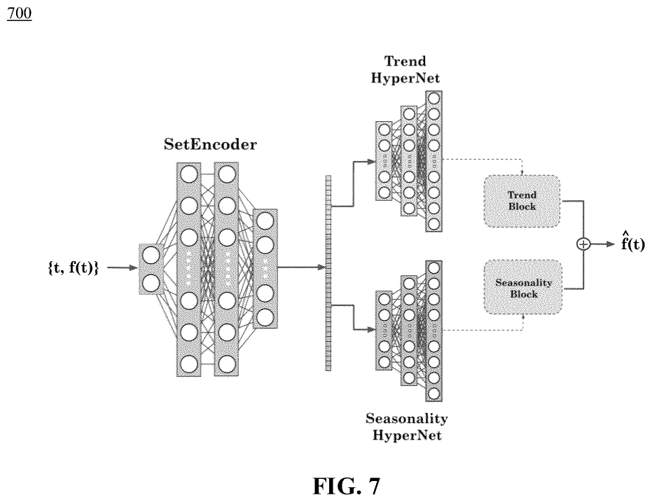

FIG. 7 is a diagram 700 that illustrates a network architecture for implementing a method for using implicit neural representations for generation of interpretable time series, according to an exemplary embodiment. This architecture facilitates an ability to leverage INRs to learn priors over the space of time series. The Set Encoder, which is composed of SIREN layers with dimensions 2×128×128×40, takes as input a pair of values, corresponding to the time-coordinate t and the time series signal ƒ(t). Each pair of input values is thus encoded into a full 40-values embedding and introduced to the HyperNet decoder, which is composed of fully-connected layers with rectified linear unit (ReLU) activations, with dimensions 40×128×7500. The output of the HyperNet is a one-dimensional 7500-values embedding that contains the network weights of an INR which encodes the time series data from the input. The INR architecture used within HyperTime is the same as described above with respect to FIG. 5. In an exemplary embodiment, such predicted INRs may be referred to as HypoNets.

During the training of HyperTime, the weights predicted by the HyperNet decoder are used to instantiate a HypoNet and evaluate it on the input time-coordinate t, to produce the predicted time series value \hat{ƒ}(t). The entire chain of operations is implemented within the same differentiable pipeline, and hence the training loss can be computed as the difference between the ground truth time series signal ƒ(t) and the value predicted by the HypoNet \hat{ƒ}(t).

After training HyperTime, the Set Encoder is able to generate latent embeddings Z for entire time series. In an exemplary embodiment, these embeddings can be interpolated to synthesize new time series signals from known ones, which can be leveraged for data augmentation.

Loss: The training of HyperTime is done by optimizing the following loss, which contains an MSE reconstruction term L_{rec} and two regularization terms L_{weights} and Lₗₐₜₑₙₜ, for the network weights and the latent embeddings, respectively:

$$ℒ = {\underbrace{\frac{1}{N} {\sum }_{i = 1}^{N} {‖ f ( {t}_{i} ) - f ( {t}_{i} ) ‖}^{2}}}_{{ℒ}_{rec}} + {λ}_{1} {\underbrace{\frac{1}{W} {\sum }_{j = 1}^{W} {w}_{j}^{2}}}_{{ℒ}_{weights}} + {λ}_{2} + {\underbrace{\frac{1}{Z} {\sum }_{k = 1}^{Z} {z}_{k}^{2}}}_{{ℒ}_{latent}} + {λ}_{3} {ℒ}_{F F T} .$$

### (Expression 4)

In addition, an introduction is made of a Fourier-based loss LFFT that focuses on the accurate reconstruction of the power spectrum of the ground truth signal:

$${ℒ}_{FFT} = \frac{1}{N} {\sum }_{i = 1}^{N} ‖ F F {T [ f ( t ) ]}_{i} - F F {T [ \hat{f} ( t ) ]}_{i} ‖ . \qquad ( Expression 5 )$$

In an exemplary embodiment, it may be observed that LFFT is crucial for the accurate reconstruction of the time series signals.

Interpretability: In an exemplary embodiment, two configurations of the HyperTime architecture are provided to incorporate interpretability. In the first case, without changing the hypernetwork architecture, the INR shown in FIG. 6 is used as HypoNets. Therefore, the generated time series are separated into trend and seasonality. Secondly, interpretability may be added into the time series generation process by separating the latent vector in HyperTime in two parts, and using two hypernetworks to generate the weights of a trend HypoNet and a seasonality HypoNet, as shown in FIG. 7. One of the advantages of this second configuration is that it is possible to only interpolate the seasonality embedding of two time series, while leaving the trend fixed.

Accordingly, with this technology, a process for using implicit neural representations for generation of interpretable time series is provided.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method for generating an interpretable time series, the method being implemented by at least one processor, the method comprising:
receiving, by the at least one processor, first information that relates to an event sequence;
generating, by the at least one processor based on the first information, an implicit neural representation of the event sequence that includes a plurality of embedded values and a corresponding plurality of weights; and
using the implicit neural representation to predict at least one item of second information that relates to the event sequence and is not included in the first information.

2. The method of claim 1, wherein each of the first information and the second information includes at least one respective pairing of a time coordinate value with a time series signal value.

3. The method of claim 2, wherein the second information includes at least one interpolated pairing for which a corresponding time coordinate value indicates a time that occurs before a latest time that is indicated by time coordinate values included in the first information.

4. The method of claim 2, wherein the second information includes at least one extrapolated pairing for which a corresponding time coordinate value indicates a time that occurs after a latest time that is indicated by time coordinate values included in the first information.

5. The method of claim 1, wherein the generating of the implicit neural representation comprises applying a sinusoidal representation network that uses at least one sinusoidal function as a periodic activation function and includes fully connected layers having a predetermined dimensionality.

6. The method of claim 5, wherein the predetermined dimensionality is equal to 1×60×60×60×1.

7. The method of claim 1, wherein the implicit neural representation includes a trend component and a seasonality component.

8. The method of claim 7, wherein the second information includes a trend output and a seasonality output that is separable from the trend output.

9. The method of claim 1, wherein the event sequence comprises at least one from among a first event sequence that relates to climate modeling, a second event sequence that relates to a medical situation, a third event sequence that relates to a biological situation, a fourth event sequence that relates to a retail situation, and a fifth event sequence that relates to a financial market situation.

10. A computing apparatus for generating an interpretable time series, the computing apparatus comprising:
a processor;
a memory; and
a communication interface coupled to each of the processor and the memory,
wherein the processor is configured to:
receive, via the communication interface, first information that relates to an event sequence;
generate, based on the first information, an implicit neural representation of the event sequence that includes a plurality of embedded values and a corresponding plurality of weights; and
use the implicit neural representation to predict at least one item of second information that relates to the event sequence and is not included in the first information.

11. The computing apparatus of claim 10, wherein each of the first information and the second information includes at least one respective pairing of a time coordinate value with a time series signal value.

12. The computing apparatus of claim 11, wherein the second information includes at least one interpolated pairing for which a corresponding time coordinate value indicates a time that occurs before a latest time that is indicated by time coordinate values included in the first information.

13. The computing apparatus of claim 11, wherein the second information includes at least one extrapolated pairing for which a corresponding time coordinate value indicates a time that occurs after a latest time that is indicated by time coordinate values included in the first information.

14. The computing apparatus of claim 10, wherein the processor is further configured to generate the implicit neural representation by applying a sinusoidal representation network that uses at least one sinusoidal function as a periodic activation function and includes fully connected layers having a predetermined dimensionality.

15. The computing apparatus of claim 14, wherein the predetermined dimensionality is equal to 1×60×60×60×1.

16. The computing apparatus of claim 10, wherein the implicit neural representation includes a trend component and a seasonality component.

17. The computing apparatus of claim 16, wherein the second information includes a trend output and a seasonality output that is separable from the trend output.

18. The computing apparatus of claim 10, wherein the event sequence comprises at least one from among a first event sequence that relates to climate modeling, a second event sequence that relates to a medical situation, a third event sequence that relates to a biological situation, a fourth event sequence that relates to a retail situation, and a fifth event sequence that relates to a financial market situation.

19. A non-transitory computer readable storage medium storing instructions for generating an interpretable time series, the storage medium comprising executable code which, when executed by a processor, causes the processor to:
receive first information that relates to an event sequence;
generate, based on the first information, an implicit neural representation of the event sequence that includes a plurality of embedded values and a corresponding plurality of weights; and
use the implicit neural representation to predict at least one item of second information that relates to the event sequence and is not included in the first information.

20. The storage medium of claim 19, wherein each of the first information and the second information includes at least one respective pairing of a time coordinate value with a time series signal value.
